(19) United States
(12) Patent Application Publication
(10) Pub. No.: US 2010/0207061 A1
(43) Pub. Date: Aug. 19, 2010

(54) Preparation Method of Metal Oxide from Metal Halide by Dehydro Halogenation with Base and Metal Oxide Prepared Therefrom

(76) Inventor: Jong-Hoon Kim, Daejeon (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 12/668,834

(22) PCT Filed: Jul. 11, 2008
(86) PCT No.: PCT/KR2008/004115

§ 371 Date: Mar. 1, 2010

(30) Foreign Application Priority Data
Jul. 13, 2007 (KR) 10-2007-0070491

(51) Int. Cl. C01G 49/06; C01F 7/02; C09K 3/00

(52) U.S. Cl. 252/182.33; 423/625; 423/633

(57) ABSTRACT

The present invention relates to a preparation method of metal oxide, and more specifically to a preparation method of metal oxide comprising the steps of: a) dissolving metal halide in a solvent; b) adding and reacting water or metal hydroxide having strong basicity; c) adding base to the reaction solution and then raising a temperature thereof to form the metal oxide-carbon complex; d) stopping the reaction by inputting a large amount of water or metal hydroxide and raising the temperature thereof; and e) obtaining the metal oxide-carbon complex by a separation and a cleaning.

### TECHNICAL FIELD

The present invention relates to a direct preparation method of metal oxide on solution from metal halide, and more particularly to a preparation method of metal oxide by condensation removing acid from inorganic monomer, comprising the steps of preparing inorganic monomer using water or metal hydroxide from metal halide and then adding base not providing water and raising a temperature of a reaction system, and metal oxide prepared therefrom.

### BACKGROUND ART

A preparation technology of fine metal oxide in the related art prepares metal hydroxide and then converts it into metal oxide through a firing process or is prepared by a sol-gel method. Therefore, it is difficult to prepare particles having a nanoscale without the help of surfactant, etc. and to prevent the re-aggregation of powders in the firing process, etc. during the preparation of powders.

The inventor has studied a method of preparing metal oxide having a nanosize and then not re-aggregating the metal oxide. During the study, the inventor completes the present invention by knowing that the metal oxide can be synthesized using a self assembly phenomenon from condensation using dehydrohalogenation of inorganic monomer, which is intermediate formed by partially substituting halide of the metal halide with hydroxide, and can also be mass-produced at low cost.

### DISCLOSURE

### [Technical Problem]

To solve the problem, an object of the present invention provides a new method of preparing fine metal oxide particles economically and in large quantities.

Another object of the present invention provides a new method capable of easily preparing metal oxide particles having improved dispersibility without adopting an unnecessary process involved in a high-temperature heating scheme or a catalyst scheme used for preparing existing metal oxide

### [Technical Solution]

The invention includes a process of preparing inorganic monomer, which is partially substituted halide of the metal halide with hydroxide, by dissolving the metal halide in a solvent and adding less amount of water or metal hydroxide having strong basicity than stoichiometrically equivalent amount of the halide in metal halide and a process of synthesizing metal oxide using a self assembly phenomenon by putting base not providing water, that is, ammonia, amine, or metal alkoxide in a reaction system including the inorganic monomer and raising the temperature the reaction system so as to perform condensation on the inorganic monomer through dehydrohalogenation using the base.

There is provided a preparation method of metal oxide according to the present invention comprising the steps of:

a) dissolving metal halide in a solvent;

b) adding and reacting water or metal hydroxide having strong basicity; and

c) adding base to the reaction solution and then raising a temperature thereof to form the metal oxide;

after the step c), further comprising:

d) stopping the reaction by inputting a large amount of water or metal hydroxide and raising the temperature thereof; and

e) obtaining the metal oxide by a separation and a cleaning.

Hereinafter, each preparation step of the present invention will be described.

In the step a) of the preparation method, metal of the metal halide is at least one metal selected from strontium, barium, aluminum, silicon, scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, gallium, indium, thallium, germanium, tin, lead, arsenic, antimony, bismuth, polonium, cerium, praseodymium, neodymium, promethium, samarium, europium, gadolinium, terbium, dysprosium, holmium, erbium, thulium, ytterbium, and lutetium, etc. An example of the metal halide may include anhydrous aluminum chloride, anhydrous ferric chloride, anhydrous scandium chloride(III) (ScCl₃), anhydrous zirconium chloride (IV) (ZrCl₄), anhydrous zinc chloride, anhydrous palladium chloride (II) (PdCl₂), anhydrous bromo tungsten (V)(WBr₅), anhydrous bromo titanium (IV)(TiBr₄), anhydrous iodo thallium (I)(TII), etc.

It is possible to simultaneously input several metal halides and perform the reaction and to prepare several types of products by controlling the input order and time until an input of subsequent materials.

As the solvent used for the reaction, any solvents are not largely limited if well dissolving the metal halide. Preferably, alcohols having a carbon number of about 1 to 12, such as methanol, ethanol, propanol, butanol, pentanol, hexanol, heptanol, octanol, nonanol, decanol, etc. and ethyleneglycol, diethyleneglycol, triethleneglycol, and polyethylene glycol are used as the solvents.

In the step a) of the preparation method, the dissolving temperature is not largely limited, but generally is between 0 and 50° C.

The step b) is a step of adding and reacting water or metal hydroxide having strong basicity to metal halide solution prepared in the step a) to form the inorganic monomer as intermediate by partially substituting halide of metal halide with hydroxide. The metal hydroxide may include sodium hydroxide, potassium hydroxide, lithium hydroxide, calcium hydroxide, etc, but is not limited thereto.

In order to partially substitute the halide of metal halide with the hydroxide, when adding water and metal hydroxide, the amount of the hydroxide (OH) should be input to be less than equivalent amount of the halide of metal halide. The amount of the hydroxide is preferably 0.3 to 0.7 equivalent to the halide, more preferably 0.4 to 0.6. The amount of the hydroxide(OH) should be controlled to the said range to easily perform condensation through the dehydrohalogenation by base so that the metal oxide particles can be formed well, but if the hydroxide is out of said range, the metal oxide particles can be formed well.

For example, in order for the amount of the hydroxide to be 0.5 equivanent for the halide of metal halide, when preparing the inorganic monomer, for divalent metal halide water of 1 mole is used, for trivalent metal halide water of 3/2 mole is used, for tetravalent metal halide water of 2 mole is used. When the number of hydroxide is one per one molecule of metal hydroxide having strong basicity, the inorganic monomer is prepared using the hydroxide having the same equivalent as water and when the number of hydroxide is two, the inorganic monomer is prepared using the hydroxide having ½ equivalent of water.

In the case of converting halogen into an alkoxide type in the reaction process, when computing the equivalent of the inorganic monomer, the halogen in the alkoxide type is included in the number of the halogen. In other words, the inorganic monomer of the present invention is prepared so that the ratio (A:B) of a total number A including the number of alkoxide and the number of halogen in the monomer to the number B of alkoxide is 7˜3:3˜7, more preferably 4˜6:6˜4.

When preparing the inorganic monomer, as the relative ratio of the hydroxide is increased, the surface of the metal oxide is increased and the size of the metal oxide particle is small, so that the molecular weight of the metal oxide is reduced.

When inputting water or metal hydroxide, the water or the metal hydroxide diluted with various solvents is preferably input so as to be uniformly reacted in the entire reaction system and a mechanochemical method is preferably used so as to be entirely dispersed well. In other words, it is preferable to use strong stirring capable of performing the dispersion within a short time and dispersion technologies, such as dispersion using an ultrasonic wave, etc.

The step c) is a step of forming the metal oxide by the condensation of the inorganic monomer through the dehydrohalogenation by adding the base to the reaction solution in which the inorganic monomer is formed and raising the temperature thereof.

As the base, any compounds having high basicity can be used without large limitation. Preferably, alkali metal alkoxide, ammonia, primary amine, secondary amine, tertiary amine, quaternary amine, amine compound including several amine groups in one molecule and amine compounds in a hetero stat from other elements or a mixture thereof can be used. An example of the base may include aniline, trimethylamine, pyridine, 2,6-dimethylpyridine, imidazole, hydrazine, aziridine, 2,2,2-trifluoroethylamine, morpholine, N-alkylmorpholine, DABCO, 4-dimethylaminopyridine, ethylamine, triethylamine, diethylamine, piperidine, pyrrolidine, DBU, guanidine, phentamethylguanidine, phenylamide, indol, pyrrole, diphenylamine, p-nitroamine, etc.

Also, the reaction temperature of the step c) in the present invention is not largely limited, but is preferably in the range of 10 to 200° C., more preferably 30-150° C., most preferably 80 to 120° C. If the temperature is too low, the progress speed of the dehalogenation is too slow and if the temperature is too high, it is difficult to control the form of products.

The reaction time in the present invention is preferably between 1 hour and 48 hours, more preferably 2 hours and 24 hours. If the reaction time is too short, the reaction yield is reduced and if the reaction time is too long, it is not good economically. Therefore, considering the reaction yield and the economical efficiency, it is preferable to control the reaction time in the same range.

When performing this reaction, the reaction rate is controlled by controlling the basicity of the base or the reaction temperature. Also, in the closed system, when the condensation of the inorganic monomer is performed by increasing the pressure upon raising the temperature due to a use of a solvent having a low boiling point, the densified metal oxide structure can be prepared.

The reaction is ended by inputting the water or inputting the metal hydroxide having strong basicity. Then, the metal oxide is obtained through general separation and cleaning processes.

Also, when performing the condensation of the inorganic monomer, a synthesizing method of carbon by performing dehydrohalogenation on compound having the ratio of hydrogen to halogen being 1:1 among compounds containing carbon, hydrogen, and halogen of Patent No. 2008-0022672 filed by the inventor is performed at the same time, making it possible to prepare a new composite of the metal oxide and the carbon. The detailed preparation method includes the following steps.

a) dissolving metal halide in a solvent;

b) adding and reacting water or metal hydroxide having strong basicity;

c) adding organic compound having the ratio of the number of hydrogen atoms and the number of the halogen atoms being 1:1 and base to the reaction solution and then raising a temperature thereof to form the metal oxide-carbon composite;

d) stopping the reaction by inputting a large amount of water or metal hydroxide and raising the temperature thereof; and

e) obtaining the metal oxide-carbon complex by a separation and a cleaning.

Also, when the condensation of the inorganic monomer is performed, the form of the metal oxide and the new composite of the metal oxide and the carbon can be changed by using surfactant, etc. and the particles and the structures in several forms can be prepared.

### DESCRIPTION OF DRAWINGS

The above and other objects, features and advantages of the present invention will become apparent from the following description of preferred embodiments given in conjunction with the accompanying drawings, in which:

FIG. 1 is an XPS result of iron oxide prepared according to an embodiment 2 of the present invention;

FIG. 2 is an XRD pattern of iron oxide prepared according to the embodiment 2 of the present invention;

FIG. 3 is a TEM photograph (20 nm scale) of iron oxide prepared according to the embodiment 2 of the present invention; and

FIG. 4 is a TEM photograph (4 nm scale) of iron oxide prepared according to the embodiment 2 of the present invention

### BEST MODE

Hereinafter, the embodiments preparing metal oxide by preparing inorganic monomer from metal halide according to the present invention will be described in detail, but the present invention is not limited thereto.

### Embodiment 1

Anhydrous aluminum chloride of 8 g (0.06 mol) dissolved in isobutanol of 200 g and water of 1.62 g (0.09 mol) well diluted in isobutanol of 100 g are mixed and stirred for one hour. Thereafter, 4-methylmorpholine of 200 g is further added to obtain a reaction mixture. The reaction mixture is poured into a high-pressure reactor and the temperature of the reaction mixture is raised to 120° C. under stirring and then reacted for 24 hours. Thereafter, water of log is further added and the temperature of the reaction mixture is then raised to 120° C. The further reaction is performed for two hours to stop the reaction. Thereafter, the particles are separated by a centrifuge and water is then input. They are separated and cleaned three times by the centrifuge and are then dried to obtain products. It can be known from analysis results for elements of the products that aluminum oxide having the mole ratio of aluminum to oxygen being 2:3 is produced.

### Embodiment 2

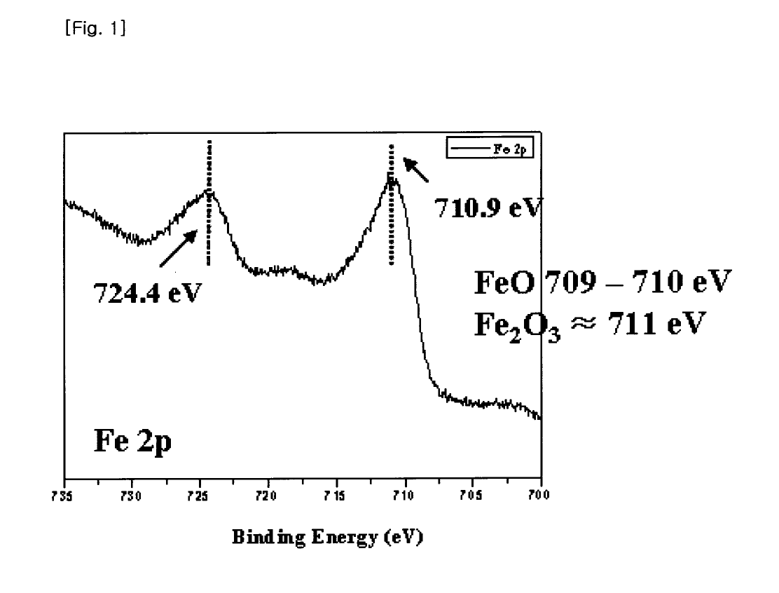

Anhydrous ferric chloride of log (0.06 mol) dissolved in ethanol of 200 g and water of 1.98 g (0.11 mol) more than 0.09 mol well diluted in ethanol of 100 g is mixed and stirred for one hour. Thereafter, 4-methylmorpholine of 200 g is further added to obtain a reaction mixture and the reaction mixture is stirred and reacted by raising the temperature to 80° C. Thereafter, water of 10 g is further added and the temperature of the reaction mixture is then raised to 80° C. The further reaction is performed for two hours to stop the reaction. Thereafter, the particles are separated by a centrifuge and water is then input. They are separated and cleaned three times by the centrifuge and are then dried to obtain products. It can be known from analysis results for elements of the products that iron oxide having the mole ratio of iron to oxygen being 2:3 is produced. Also, it can be confirmed that the iron oxide can be prepared by the analysis of the XPS (see FIG. 1).

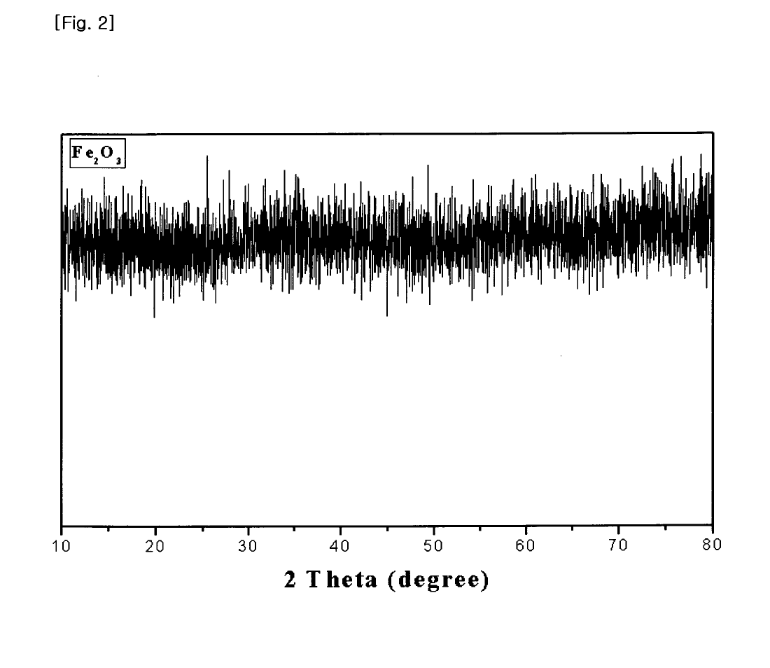

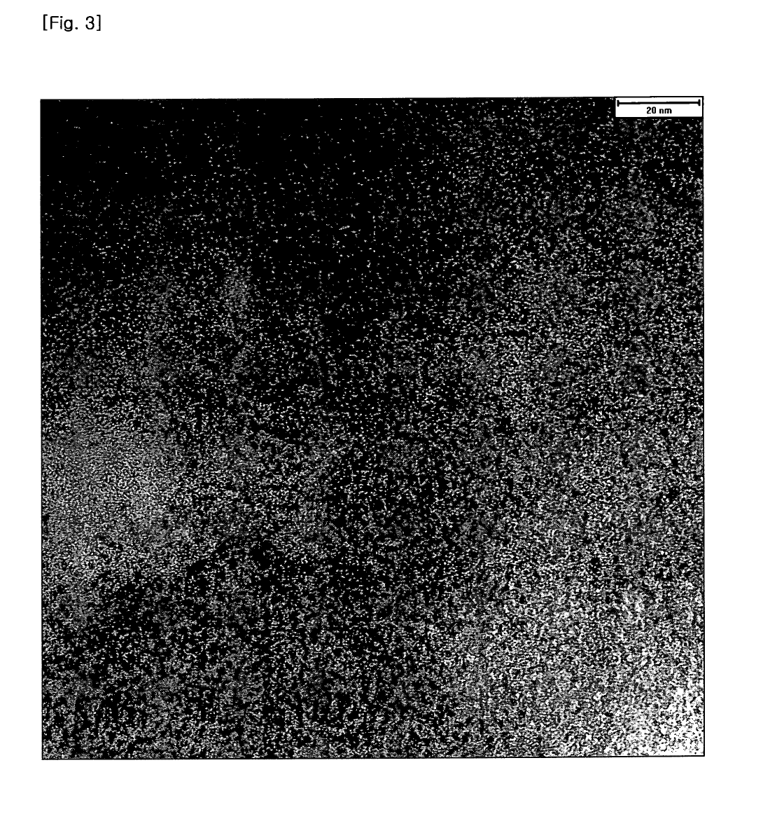

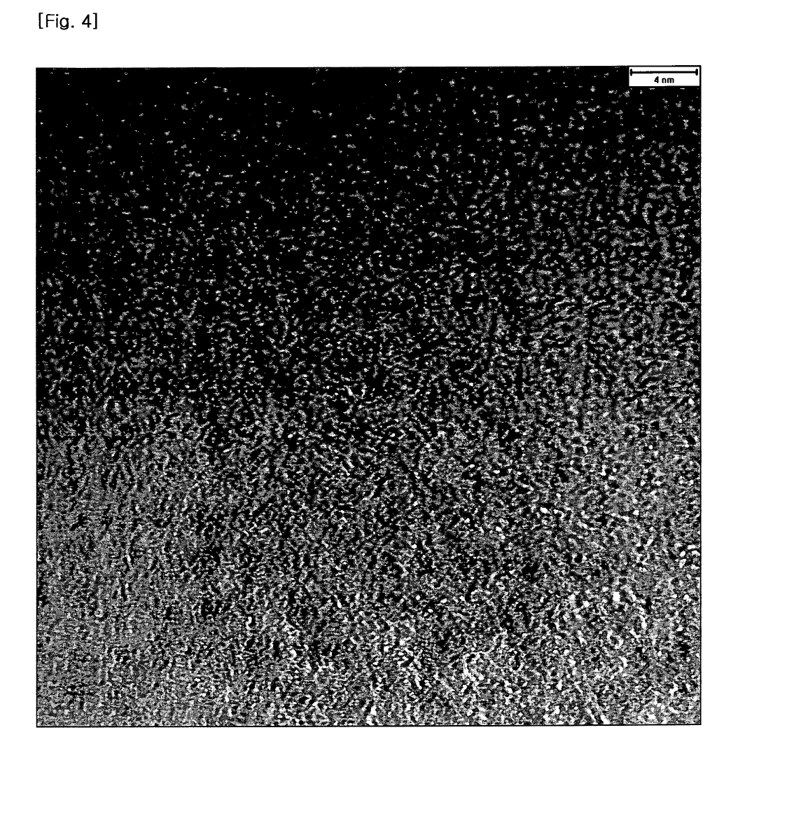

From the analysis results of the prepared iron oxide by the XRD, the particles are too small so that its crystallization is not shown (see FIG. 2). FIGS. 3 and 4 show TEM photographs thereof. Referring to FIGS. 3 and 4, it can be known that the size of the primary particle of the iron oxide is formed at about 1 to 2 nm.

### Embodiment 3

Anhydrous ferric chloride of 10 g (0.06 mol) dissolved in ethanol of 200 g and water of 1.62 g (0.09 mol) well diluted in ethanol of 100 g is mixed. Then, vinylidene chloride of 20 g and 4-methylmorpholine of 200 g is further added to obtain the reaction mixture. The reaction mixture is poured into a high-pressure reactor and the temperature of the reaction mixture is raised to 140° C. under stirring and then reacted for 24 hours. Thereafter, water of log is further added and the temperature of the reaction mixture is then raised to 140° C. The further reaction is performed for two hours to stop the reaction. Thereafter, the particles are separated by a centrifuge and water is then input. They are separated and cleaned three times by the centrifuge and are then dried to obtain products being a black material. It can be known that the composite of iron oxide and carbon can be prepared.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

### INDUSTRIAL APPLICABILITY

The present invention provide a new method of directly preparing the metal oxide, comprising the preparation of the inorganic monomer by the reaction substituting metal halide with quantitative hydroxide and the dehydrohalogenation of the inorganic monomer by the base at raised temperature, showing that very fine metal oxide particles can be economically prepared.

1. A preparation method of metal oxide comprising the steps of:
a) dissolving metal halide in a solvent;
b) adding and reacting water or metal hydroxide having strong basicity; and
c) adding base to the reaction solution and then raising a temperature thereof to form the metal oxide.

2. The preparation method of metal oxide according to claim 1, further comprising the steps of:
after the step c),
d) stopping the reaction by inputting a large amount of water or metal hydroxide and raising the temperature thereof ; and
e) obtaining the metal oxide by a separation and a cleaning.

3. The preparation method of metal oxide according to claim 1, wherein the metal of metal halide is at least one metal selected from strontium, barium, aluminum, silicon, scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, gallium, indium, thallium, germanium, tin, lead, arsenic, antimony, bismuth, polonium, cerium, praseodymium, neodymium, promethium, samarium, europium, gadolinium, terbium, dysprosium, holmium, erbium, thulium, ytterbium, and lutetium.

4. The preparation method of metal oxide according to claim 1, wherein the base is any one selected from alkali metal alkoxide, ammonia, or amine.

5. The preparation method of metal oxide according to claim 1, wherein in the step b), the water or the metal hydroxide are added so that the hydroxide (OH) is 0.3 to 0.7 equivalent to the halide of metal halide.

6. The preparation method of metal oxide according to claim 5, wherein in the step b), the water or the metal hydroxide is added so that the hydroxide (OH) is 0.4 to 0.6 equivalent to the halide of metal halide.

7. The preparation method of metal oxide according to claim 1, wherein the step c) forms the metal oxide by raising the temperature between 30 to 150° C.

8. The preparation method of metal oxide according to claim 7, wherein in the step c), the reaction time forming the metal oxide is in 2 hours to 24 hours.

9. A preparation method of metal oxide comprising the steps of:
a) dissolving metal halide in a solvent;
b) adding and reacting water or metal hydroxide having strong basicity; and
c) adding organic compound having the ratio of the number of hydrogen atoms and the number of the halogen atoms being 1:1 and base to the reaction solution and then raising a temperature thereof to form the metal oxide-carbon composite.

10. The preparation method of metal oxide according to claim 9, further comprising:
after the step c),
d) stopping the reaction by inputting a large amount of water or metal hydroxide and raising the temperature thereof; and
e) obtaining the metal oxide-carbon composite by a separation and a cleaning.
